(19) United States
(12) Patent Application Publication
(10) Pub. No.: US 2012/0269263 A1
(43) Pub. Date: Oct. 25, 2012

(54) METHOD FOR CODING AND METHOD FOR RECONSTRUCTION OF A BLOCK OF AN IMAGE

(75) Inventors: Philippe Bordes, Cesson Sevigne Cedex (FR); Dominique Thoreau, Cesson Sevigne Cedex (FR); Jerome Vieron, Paris (FR); Edouard Francois, Bourg des Comptes (FR)

(73) Assignee: Thomson Licensing

(21) Appl. No.: 13/509,813

(22) PCT Filed: Nov. 8, 2010
(86) PCT No.: PCT/EP2010/067056

§ 371 Date: Jul. 16, 2012

(30) Foreign Application Priority Data
Nov. 19, 2009 (FR) 0958188

(51) Int. Cl. H04N 7/50; H04N 7/26

(52) U.S. Cl. 375/240.03; 375/240.12; 375/240.16; 375/E07.027; 375/E07.125; 375/E07.211; 375/E07.139

(57) ABSTRACT

A method for coding a current block of an image is disclosed that comprises:
determining, for the current block, current coding parameters,
determining, for at least one neighbouring block of the current block previously coded and reconstructed, a neighbouring residual block from current coding parameters, and
coding the current block with the current coding parameters according to the neighbouring residual block.

### 1. SCOPE OF THE INVENTION

The invention relates to the general domain of image coding. More specifically, the invention relates to a method for coding a block of an image and a method for reconstructing such a block.

### 2. PRIOR ART

It is known in the prior art to code a current block Bc of an image according to the content of a block or blocks of a neighbouring block or blocks of the current block Bc. In fact, the content of the current block and the content of neighbouring blocks are often correlated. For example and in reference to FIG. 1, the content of blocks I, M, A and B or of some of them is taken into account to code the current block Bc. More specifically, the content of neighbouring blocks taken into account is the content of these neighbouring blocks after their coding and at least partial reconstruction.

It is also known to code the current block Bc of an image belonging to a sequence of several images according to the content of blocks, called reference blocks, of other image(s) of the sequence, called reference images, the reference images being identified by an item of motion data, for example a motion vector. In fact, the content of the current block Bc and the content of reference blocks are often correlated. The content of reference blocks taken into account is the content of these reference blocks after their coding and at least partial reconstruction. It is known in the prior art to code for the current block Bc the motion vector(s) identifying the reference blocks according to prediction motion vector(s) determined from motion vectors associated with neighbouring blocks of the current block Bc.

Moreover it is known, to code the current block Bc, to determine a prediction block, known as the second order prediction block, from neighbouring reconstructed residues blocks. The second order prediction block is then used to predict a current residues block. The current residues block is typically determined by prediction of the current block from a prediction block, called the first order prediction block, identified for example in the same image or in another image using a motion vector.

However, even if the content of the current block and the content of the neighbouring blocks or the reference blocks are correlated at the origin, the content of the current block and the content of the neighbouring blocks or the reference blocks at least partially reconstructed are no longer necessarily correlated or are less so due to the coding then the reconstruction of these neighbouring or reference blocks.

### 3. SUMMARY OF THE INVENTION

The purpose of the invention is to overcome at least one of the disadvantages of the prior art. For this purpose, the invention relates to a method for coding a current block of an image. The method comprises the steps for:

determining, for the current block, current coding parameters,

determining, for at least one neighbouring block of the current block previously coded and reconstructed, a neighbouring residual block from current coding parameters, and

coding the current block with current coding parameters according to the neighbouring residual block.

According to a particular aspect of the invention, the step of determination of a neighbouring residual block comprises steps for:

determining, for the neighbouring block, a prediction block using the current coding parameters, and

determining the neighbouring residual block by extracting from the reconstructed neighbouring block the prediction block.

According to a particular characteristic of the invention, the current block being an INTRA type block predicted from neighbouring pixels, the step of determination of a neighbouring residual block comprises the following steps for:

determining, for the neighbouring block, a prediction block from neighbouring pixels using the current coding parameters, and

determining the neighbouring residual block by extracting from the reconstructed neighbouring block, the prediction block.

Advantageously, the step of coding of the current block according to the neighbouring residual block comprises steps for:

determining for the current block at least one coding tool according to the neighbouring residual block, and

coding the current block with the at least one coding tool.

According to a particular characteristic of the invention, the step of determination for the current block of at least one coding tool comprises the determination of a scanning order of coefficients of the current block for the purpose of coding of coefficients.

According to another particular characteristic of the invention, the step of determination for the current block of at least one coding tool comprises the determination of a transform.

Advantageously, the step of coding of the current block according to the neighbouring residual block comprises steps for:

determining for the current block a current prediction block,

determining for the current block a first residual block by extracting from the current block the current prediction block,

determining a residues prediction block from the neighbouring residual block, and

determining for the current block a second residual block by extracting from the first block of residues, the residues prediction block,

coding the second residual block.

The invention also relates to a method for reconstruction of a current block of an image in the form of a stream of coded data comprising the following steps for:

decoding, for the current block, current coding parameters from the stream of coded data,

determining, for at least one block spatially neighbouring the current block previously reconstructed, a neighbouring residual block resulting from the coding of a neighbouring block with the current coding parameters, and

reconstructing the current block according to the neighbouring residual block.

According to a particular aspect of the invention, the step of reconstruction of the current block according to a neighbouring residual block comprises steps for:

determining for the current block at least one coding tool according to the neighbouring residual block, and

reconstructing the current block with the at least one coding tool.

According to another particular aspect of the invention, the step of reconstruction of the current block according to a neighbouring residual block comprises steps for:

reconstructing for the current block a residual block from the stream of coded data,

determining for the current block a current prediction block,

determining a residues prediction block from the neighbouring residual block, and

reconstructing the current block by merging the residual block, the current prediction block and the residues prediction block.

### 4. LIST OF FIGURES

The invention will be better understood and illustrated by means of embodiments and advantageous implementations, by no means limiting, with reference to the figures in the appendix, wherein:

FIG. 2 shows a current block Bc and its neighbouring blocks I, M, A and B,

FIG. 2 shows a method for coding of a current block according to the invention,

FIG. 3 shows a particular first step of the coding method according to the invention,

FIG. 4 shows a current block Bc and a neighbouring block reconstructed in a current image Ic and their respective reference blocks identified by a motion vector MV1,

FIGS. 5 and 6 show a current block Bc and a reconstructed neighbouring block,

FIGS. 7 and 8 show a current block Bc and a reconstructed neighbouring block in a current image Ic and their respective prediction blocks,

FIG. 9 shows a particular second step of the coding method according to a first embodiment,

FIG. 10 shows a block of coefficients and an scanning order of its coefficients for the purpose of their coding,

FIG. 11 shows a particular second step of the coding method according to a second embodiment,

FIG. 12 shows a method for reconstruction of a current block according to the invention,

FIG. 13 shows a particular step of the reconstruction method according to a first embodiment,

FIG. 14 shows a particular step of the reconstruction method according to a second embodiment,

FIG. 15 shows a coding device according to the invention, and

FIG. 16 shows a decoding device according to the invention.

### 5. DETAILED DESCRIPTION OF THE INVENTION

An image sequence is a series of several images. Each image comprises pixels or image points, with each of which is associated at least one item of image data. An item of image data is for example an item of luminance data or an item of chrominance data.

The term “motion data” is to be understood in the widest sense. It comprises the motion vectors and possibly the reference image indexes enabling a reference image to be identified in the image sequence. It can also comprise an item of information indicating the interpolation type used to determine the prediction block. In fact, in the case where the motion vector associated with a block Bc does not have integer coordinates, the image data must be interpolated in the reference image Iref to determine the prediction block Bp. The motion data associated with a block are generally calculated by a motion estimation method, for example by block pairing. However, the invention is in no way limited by the method enable a motion vector to be associated with a block.

The term “residual data” signifies data obtained after extraction of other data. The extraction is generally a subtraction pixel by pixel of prediction data from source data. However, the extraction is more general and comprises notably a weighted subtraction. The term “residual data” is synonymous with the term “residues”. A residual block is a block of pixels with which residual data is associated.

The term “transformed residual data” signifies residual data to which a transform has been applied. A DCT (Discrete Cosine Transform) is an example of such a transform described in chapter 3.4.2.2 of the book by I.E. Richardson entitled “H.264 and MPEG-4 video compression”, published by J. Wiley & Sons in September 2003. The wavelet transforms described in chapter 3.4.2.3 of the book by I. E. Richardson and the Hadamard transform are other examples. Such transforms “transform” a block of image data, for example residual luminance and/or chrominance data, into a “block of transformed data” also called a “block of frequency data” or a “block of coefficients”.

The term “prediction data” signifies data used to predict other data. A prediction block is a block of pixels with which prediction data is associated. A prediction block is obtained from a block or several blocks of the same image as the image to which belongs the block that it predicts (spatial prediction or intra-image prediction) or from one (mono-directional prediction) or several blocks (bi-directional prediction) of a different image (temporal prediction or inter-image prediction) of the image to which the block that it predicts belongs.

The term “prediction mode” specifies the way in which the block is coded. Among the prediction modes, there is the INTRA mode that corresponds to a spatial prediction and the INTER mode that corresponds to a temporal prediction. The prediction mode possibly specifies the way in which the block is partitioned to be coded. Thus, the 8×8 INTER prediction mode associated with a block of size 16×16 signifies that the 16×16 block is partitioned into 4 8×8 blocks and predicted by temporal prediction.

The term “reconstructed data” signifies data obtained after merging of residual data with prediction data. The merging is generally a sum pixel by pixel of prediction data to residual data. However, the merging is more general and comprises notably the weighted sum. A reconstructed block is a block of pixels with which reconstructed image data is associated.

A neighbouring block of a current block is a block located in a neighbourhood more or less close to the current block but not necessarily adjacent. A pixel (respectively block) co-located to a current pixel (respectively current block) is a pixel located at the same position in a different image.

The term coding is to be taken in the widest sense. The coding can possibly but not necessarily comprise the transformation and/or the quantization of image data. Likewise, the term coding is used even if the image data are not explicitly coded in binary form, i.e. even when a step of entropy coding is omitted.

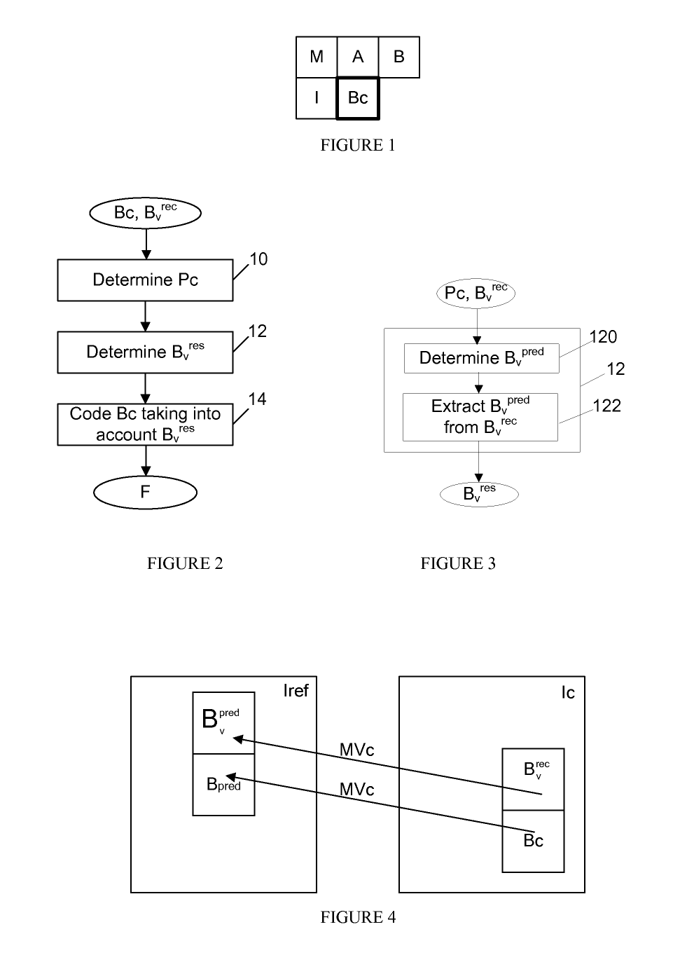

In reference to FIG. 2, the invention relates to a method for coding a current block Bc of a current image Ic.

During a step 10, coding parameters Pc are determined for the current block Bc. For example, the coding parameters are a prediction mode (for example INTER/INTRA mode, type of partitioning), possibly motion data (for example motion vector, reference image index). It is known in order to determine such coding parameters Pc to select among the set of possible parameters the set of parameters that minimise for the current block Bc a function of bitrate-distortion type. The retained set of parameters is that which offers the best coding cost/distortion compromise. Such a method is relatively costly. It is also known to determine such coding parameters Pc by pre-selecting a certain number of parameters according to an a priori analysis of the current block Bc. For example, the INTRA prediction mode can be selected according to an analysis of directional gradients in the blocks neighbouring the current block Bc. In fact, if the analysis of directional gradients shows the presence in these blocks of strong horizontal gradients, this indicates the presence of vertical lines. In this case, a vertical INTRA prediction mode is preferred. The invention is in no way limited by the method used to determine the coding parameters Pc. Any method is suitable.

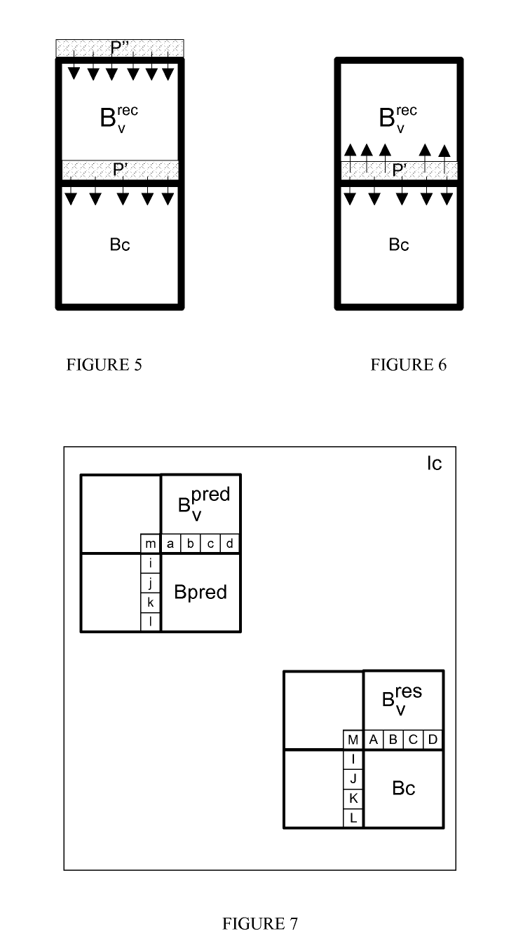

During a step 12, a neighbouring residual block Bᵥ^{res} is determined for at least one neighbouring block Bv previously coded and reconstructed from coding parameters Pc. For this purpose, in reference to FIG. 3, a prediction block Bᵥ^{pred} is determined for the reconstructed neighbouring block Bᵥ^{rec} using coding parameters Pc during a step 120. During a step 122, the neighbouring residual block Bᵥ^{res} is determined by extracting from the neighbouring block Bv the prediction block Bᵥ^{pred}. For example, if the coding parameters Pc determined for the current block Bc in step 10 are the following: 16×16 INTER prediction mode, motion vector MVc and reference image Iref, then the prediction block of the reconstructed neighbouring block Bᵥ^{rec} is determined from the same coding parameters as shown in FIG. 4. According to another example, if the coding parameters Pc determined for the current block Bc in step 10 are the following: vertical 16×16 INTRA prediction mode, then the prediction block of the reconstructed neighbouring block Bᵥ^{rec} is determined from the same coding parameters Pc as shown in FIG. 5. In this figure, the prediction block of the reconstructed neighbouring block Bᵥ^{rec} is determined from the pixels P″ that belong to the block located just above the reconstructed neighbouring block Bᵥ^{rec}.

According to a variant, when the current block is an INTRA type block predicted from neighbouring pixels, the prediction block of the reconstructed neighbouring block Bᵥ^{rec} is determined from the same coding parameters Pc and the same pixels P′ as those used to predict the current block. For example, if the coding parameters Pc determined for the current block Bc in step 10 are the following: vertical 16×16 INTRA prediction mode, then the prediction block of the reconstructed neighbouring block Bᵥ^{rec} is determined from the same coding parameters Pc and the same pixels P′ as those used to predict the current block Bc as shown in FIG. 6. In this figure, the prediction block of the reconstructed neighbouring block Bᵥ^{rec} is determined from the pixels P′ that belong to this neighbouring block.

According to yet another variant, when the current block is a block of INTRA type predicted from pixels belonging to another block of the image Ic to which belongs the current block Bc identified by a template matching method, the prediction block of the reconstructed neighbouring block Bᵥ^{rec} is determined from the same coding parameters Pc and the same pixels as those used to predict the current block. For example, if the coding parameters Pc determined for the current block Bc in step 10 are the following: 4×4 INTRA prediction mode by template matching, then the prediction block of the reconstructed neighbouring block Bᵥ^{rec} is determined from the same coding parameters and the same reconstructed neighbouring pixels L, K, J, I, M, A, B, C, D as those used to predict the current block Bc as shown in FIG. 7. According to the template matching prediction method, the prediction block of the current block Bc is determined by searching in the current image Ic, the template comprising the pixels l, k, j, i, m, a, b, c and d that best match the neighbouring pixels L, K, J, I, M, A, B, C, D of the current block. For example, the pixels l, k, j, i, m, a, b, c and d are those that minimise the sum of absolute values of differences pixel by pixel, i.e.

$${arg min}_{( l , k , j , i , m , a , b , c , d )} ( \vert L - l \vert + \vert K + k \vert + \vert J - j \vert + \vert I - i \vert + \vert M - m \vert + \vert A - a \vert + \vert B - b \vert + \vert C - c \vert + \vert D - d \vert ) .$$

Once the template l, k, j, i, m, a, b, c and d are identified in the image Ic, the prediction block Bp and the prediction block Bᵥ^{pred} are determined directly. They occupy the same position relative to the template l, k, j, i, m, a, b, c and d as the position occupied by the blocks Bc and Bᵥ^{rec} relative to the template L, K, J, I, M, A, B, C, D.

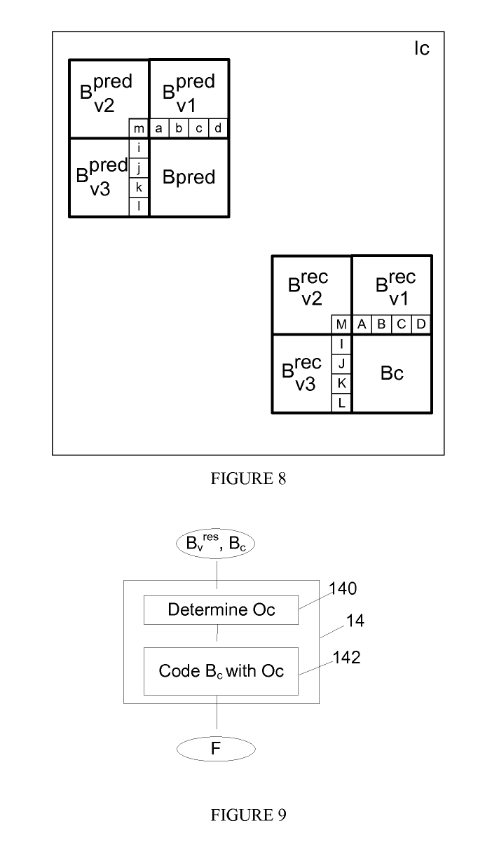

In the variants presented below, a neighbouring residual block Bᵥ^{res} is determined for a single neighbouring block Bv of the current block Bc previously coded and reconstructed. According to another variant, several neighbouring residual blocks are determined from several prediction blocks Bᵥ^{pred} as shown in FIG. 8.

During a step 14, the current block Bc is coded taking into account the neighbouring block of residues Bᵥ^{res}. According to a first embodiment shown in FIG. 9, the coding of the current block Bc comprises the determination 140 for the current block of at least one coding tool Oc according to the neighbouring block of residues Bᵥ^{res} and the coding 142 of the current block with this coding tool Oc. It is known in order to code a current block to transform the image or residues into coefficients using a transform. This transform can be selected in a set of several transforms, the choice being made according to Bᵥ^{res}. For example, the transform chosen is that which minimises the coding cost of the block Bᵥ^{res}. More precisely, the neighbouring block of residues Bᵥ^{res} is transformed, possible quantized then coded by entropy coding with each of the transforms of the set of transforms. In each case the numbers of bits necessary for the coding of Bᵥ^{res} is determined and the transform of the set for which the number of bits is smallest is chosen. In the particular case where several neighbouring blocks of residues Bᵥ₁^{res} Bᵥ₂^{res}, Bᵥ₃^{res} are determined in step 12, the transform of the set for which the total number of bits is smallest is chosen. The total number of bits is the number of bits necessary for the coding of all the neighbouring blocks of residues determined in step 12. The transform chosen is then used to code the current block.

According to another variant, Bᵥ^{res} is used to determine a Karhunen-Loéve transform. For this purpose, an analysis in principal components is applied using as random variables the residues of the block or blocks Bᵥ^{res}.

According to yet another variant, the quantization type is chosen in the same way if several quantization types exist to code the current block Bc.

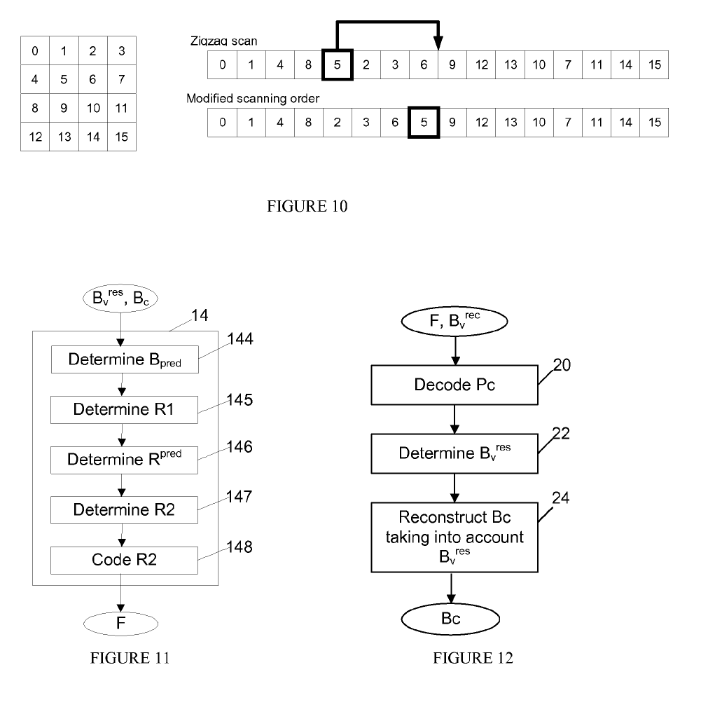

It is also known in order to code the coefficients to scan the block according to a scanning order. Generally, the scanning order of the block is fixed and known to the coder and the decoder. The scan of the block in zigzag is a known example of such a scanning order. The zigzag scanning order is shown on the left side of FIG. 10. According to the invention, the scanning order of a current block of coefficients is adapted according to Bᵥ^{res}. For example, in reference to FIG. 10, if a coefficient of the block Bᵥ^{res} is null then the corresponding coefficient in the current block Bc is displaced so as to be coded further. In fact, it is particularly advantageous to scan the block of coefficients in such a way to regroup in the end all the null coefficients, which enables the coding cost to be minimised. In fact, with a (RUN, LEVEL) type coding, the number of zeros that precede a non-null coefficient of value LEVEL are coded. It is therefore of interest to regroup in the end the null coefficients.

In the case of several neighbouring blocks, the statistics of these blocks are used. During a step 142, the current block Bc is coded from the coding tool or tools determined in step 140. The step 142 typically comprises the determination of a block of residues for the current block Bc from coding parameters Pc, the transformation, the quantization and the entropy coding of the block of residues thus determined. The transformation and/or the quantization possibly taking into account coding tools determined in step 140.

Likewise, the entropy coding possibly takes into account the scanning order determined in step 140.

According to a second embodiment shown in FIG. 11, the coding of the current block Bc comprises a second order prediction of the current block Bc. The second order prediction is the prediction of residues themselves while the first order prediction is the prediction of luminance and/or chrominance image data. For this purpose, during a step 146 a prediction block of residues is determined from a neighbouring residual block or blocks. For example, in the case where a single neighbouring residual block Bᵥ^{res} is determined in step 12, it may be considered as being the residues prediction block R^{pred}. According to a variant, the residues prediction block R^{pred} is equal to g(Bᵥ^{res}) where g(.) is a function of low-pass filtering that retains thus only the low frequencies of the neighbouring residual block Bᵥ^{res}. According to other examples g(.) is a weighting function that gives more importance to the low frequencies than to the high frequencies of the neighbouring residual block Bᵥ^{res}. In the case where several neighbouring residual blocks Bᵥ₁^{res}, Bᵥ₂^{res} and Bᵥ₃^{res} are determined in step 12, the residues prediction block R^{pred} is equal to f(Bᵥ₁^{res}, Bᵥ₂^{res}, Bᵥ₃^{res}, . . . ) where f(.) is a function enabling grouping together of several neighbouring residual blocks. For example, f(.) is the average function. In this case, each pixel of the block R^{pred} is equal to the average of corresponding pixels of neighbouring residual blocks Bᵥ₁^{res}, Bᵥ₂^{res} and Bᵥ₃^{res}. According to another example, the function f(.) is the median function. In this case, each pixel of the block R^{pred} is equal to the median of corresponding pixels of neighbouring residual blocks Bᵥ₁^{res}, Bᵥ₂^{res} and Bᵥ₃^{res}. During a step 147, a current residues block of the second order R2 is determined by extracting, for example by subtracting pixel by pixel, from a first order block of residues, the residues prediction block R^{pred}. During a step 148, the current residues block of the second order R2 is coded. This step 148 typically comprises, the transformation, quantization then the entropy coding of the second order current residues block R2. The block of residues of the first order R1 is determined during a step 145 by extracting, for example pixel by pixel, from the current block Bc, the prediction block B_{pred} The prediction block B_{pred} is itself determined during a step 144 typically for example from neighbouring blocks (INTRA mode) or blocks of another image (INTER mode) previously coded and reconstructed.

A second order prediction enables the coding cost to be reduced as the quantity of residues to be coded is lower.

The invention also relates to a method for reconstruction of a current block Bc of an image in the form of a stream F of coded data shown in FIG. 12.

During a step 20, coding parameters Pc are decoded from the stream F. For example, the coding parameters are a prediction mode (for example INTRA/INTER mode, partitioning type), possibly motion data (for example motion vector, reference image index). During a step 22, a neighbouring residual block Bᵥ^{res} is determined from current coding parameters Pc for at least one neighbouring block Bv reconstructed from the current block Bc. Step 22 of the method for reconstruction is identical to step 12 of the method for coding. Hence, all the embodiments as well as their variants described for step 12 can be applied at step 22 of the method for reconstruction. During a step 24, the current block Bc is reconstructed taking into account the neighbouring block or blocks of residues Bᵥ^{res} determined in step 22.

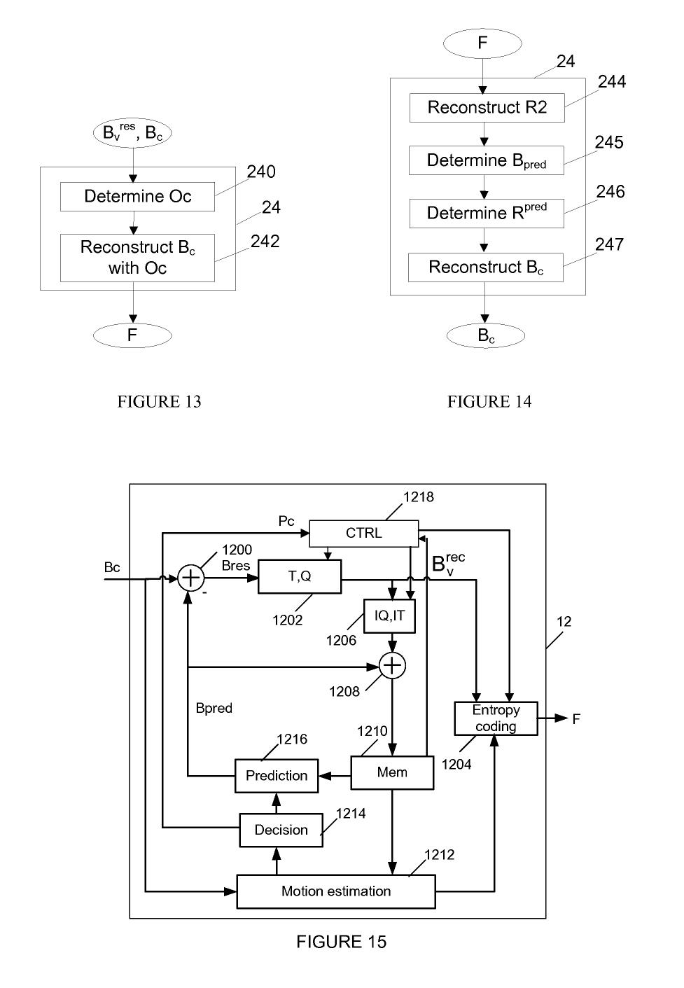

According to a first embodiment shown in FIG. 13, the reconstruction of the current block Bc comprises the determination 240 for the current block of at least one coding tool Oc according to the neighbouring block of residues Bᵥ^{res} and the reconstruction 242 of the current block with this coding tool Oc. It is known to reconstruct a current block to transform the coefficients using an inverse transform to that used by the coding method in step 14 into residues or image data. This transform can be selected in a set of several transforms, the choice being made according to Bᵥ^{res}. According to the invention, the transform is chosen in the same way as that used by the coding method during step 142. According to another variant, Bᵥ^{res} is used to determine a Karhunen-Loéve transform. For this purpose, an analysis in principal components is applied using as random variables the residues of the block or blocks Bᵥ^{res}.

According to yet another variant, the quantization type is chosen in the same way if several quantization types exist to code the current block Bc.

It is also known to reconstruct the coefficients of a block according to a scanning order of the block in a dual manner to that used during the coding of coefficients. Generally, the scanning order of the block is fixed and known to the coder and the decoder. The scan of the block in zigzag is a known example of such a scanning order. According to the invention, the scanning order of a current block of coefficients is adapted according to Bᵥ^{res} in the same way as that used by the coding method in step 142.

During a step 242, the current block Bc is reconstructed from the coding tool(s) determined in step 240. Step 242 generally comprises the reconstruction of a block of coefficients B by stream F entropy decoding, the inverse transform and inverse quantization of the block of coefficients into a block of residues, the determination of a prediction block from coding parameters Pc and the merging of the block of residues and the prediction block. The inverse transformation and/or the inverse quantization possibly taking into account coding tools determined in step 240. Likewise, the entropy decoding possibly takes into account the scanning order determined in step 240.

According to a second embodiment shown in FIG. 14, the reconstruction of the current block Bc comprises a second order prediction of the current block Bc. The second order prediction is the prediction of residues themselves while the first order prediction is the prediction of luminance and/or chrominance image data.

During a step 244, the current residues block of the second order R2 is reconstructed. This step generally comprises, the entropy decoding of at least part of F, the inverse quantization then the inverse transformation.

During a step 245, a prediction block B_{pred} is determined typically for example from neighbouring blocks (INTRA mode) or blocks of another image (INTER mode) previously reconstructed.

During a step 246 a prediction block of residues R^{pred} is determined from a neighbouring residual block or blocks. For example, in the case where a single neighbouring residual block Bᵥ^{res} is determined in step 22, it may be considered as being the residues prediction block R^{pred}. According to a variant, the residues prediction block R^{pred} is equal to g(Bᵥ^{res}) where g(.) is a function of low-pass filtering that retains thus only the low frequencies of the neighbouring residual block Bᵥ^{res}. According to other examples g(.) is a weighting function that gives more importance to the low frequencies than to the high frequencies of the neighbouring residual block Bᵥ^{res}. In the case where several neighbouring residual blocks Bᵥ₁^{res}, Bᵥ₂^{res} and Bᵥ₃^{res} are determined in step 22, the residues prediction block R^{pred} is equal to f(Bᵥ₁^{res}, Bᵥ₂^{res}, Bᵥ₃^{res}, . . . ) where f(.) is a function enabling grouping together of several neighbouring residual blocks. For example, f(.) is the average function. In this case, each pixel of the block R^{pred} is equal to the average of corresponding pixels of neighbouring residual blocks Bᵥ₁^{res}, Bᵥ₁^{res} and Bᵥ₃^{res}. According to another example, the function f(.) is the median function. In this case, each pixel of the block R^{pred} is equal to the median of corresponding pixels of neighbouring residual blocks Bᵥ₁^{res}, Bᵥ₂^{res} and Bᵥ₃^{res}.

During a step 247, the current block Bc is reconstructed by merging, for example by adding pixel by pixel, the reconstructed residues block of the second order R2, the prediction block B_{pred}, and the residues prediction block R^{pred}.

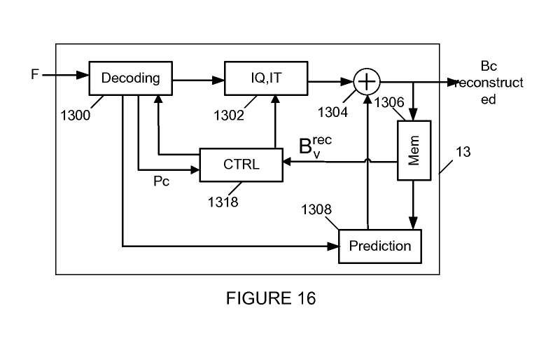

The invention also relates to a coding device 12 described in reference to FIG. 15 and a decoding device 13 described in reference to FIG. 16. In FIGS. 15 and 16, the modules shown are functional units, that may correspond or not to physically distinguishable units. For example, these modules or some of them can be grouped together in a single component, or constitute functions of the same software. Conversely, some modules may be composed of separate physical entities.

In reference to FIG. 15, the coding device 12 receives at input images belonging to a sequence of images. Each image is divided into blocks of pixels each of which is associated with at least one item of image data. The coding device 12 notably implements a coding with temporal prediction. Only the modules of the coding device 12 relating to the coding by temporal prediction or INTER coding are shown in FIG. 12. Other modules not shown and known by those skilled in the art of video coders implement the INTRA coding with or without spatial prediction. The coding device 12 notably comprises a calculation module 1200 able to extract, for example by subtraction pixel by pixel, from a current block Bc a prediction block Bpred to generate a block of residual data Bres. It further comprises a module 1202 able to transform then quantize the residual block Bres into quantized data. The transform T is for example a discrete cosine transform (or DCT). The coding device 12 further comprises an entropy coding module 1204 able to code the quantized data into a stream F of coded data. It further comprises a module 1206 performing the inverse operation of the module 1202. The module 1206 performs an inverse quantization Q⁻¹ followed by an inverse transformation T⁻¹. The module 1206 is connected to a calculation module 1208 capable of merging, for example by addition pixel by pixel, the block of data from the module 1206 and the prediction block Bp to generate a block of reconstructed image data that is stored in a memory 1210.

The coding device 12 further comprises a motion estimation module 1212 capable of estimating at least one motion vector MVc between the block Bc and a block of a reference image Iref stored in the memory 1210, this image having previously been coded then reconstructed. According to a variant, the motion estimation can be carried out between the current block Bc and the original reference image Ic in which case the memory 1210 is not connected to the motion estimation module 1212. According to a method well known to those skilled in the art, the motion estimation module searches the reference image Iref for an item of motion data, notably a motion vector in such a manner as to minimize an error calculated between the current block Bc and a block in the reference image Iref identified by means of the item of motion data.

The motion data determined are transmitted by the motion estimation module 1212 to a decision module 1214 able to select coding parameters for the current block Bc. Notably, the decision module 1214 determines a coding mode for the block Bc in a predefined set of coding modes. The decision module 1214 thus implements step 10 of the coding method. The coding mode retained is for example that which minimizes a bitrate-distortion type criterion. However, the invention is not restricted to this selection method and the mode retained can be selected according to another criterion for example an a priori type criterion. The coding mode selected by the decision module 1214 as well as the motion data, for example the motion data in the case of the temporal prediction mode or INTER mode are transmitted to a prediction module Bpred from the coding mode determined by the decision module 1214 and possibly from motion data determined by the motion estimation module 1212 (inter-images prediction). The coding mode selected and if relevant the motion data are also transmitted to the entropy coding module 1204 to be coded in the stream F. Advantageously, the coding device according to the invention comprises a control module 1218 that implements step 12 of the coding method. Step 14 of the reconstruction method is implemented in the different coding modules 1202, 1306 and 1204 particularly.

In reference to FIG. 16, the decoding module 13 receives at input a stream F of coded data representative of a sequence of images. The stream F is for example transmitted by a coding device 12 via a channel. The decoding device 13 comprises an entropy decoding module 1300 able to generate decoded data, for example coding modes and decoded data relating to the content of the images.

The decoding device 13 also comprises a motion data reconstruction module. According to a first embodiment, the motion data reconstruction module is the entropy decoding module 1300 that decodes a part of the stream F representative of said motion data. According to a variant not shown in FIG. 13, the motion data reconstruction module is a motion estimation module. This solution for reconstructing motion data via the decoding device 13 is known as “template matching”.

The decoded data relating to the content of the images is then transmitted to a module 1302 able to carry out an inverse quantization followed by an inverse transform. The module 1303 is identical to the module 1206 of the coding device 12 having generated the coded stream F. The module 1302 is connected to a calculation module 1304 able to merge, for example by addition pixel by pixel, the block from the module 1302 and a prediction module Bpred to generate a reconstructed current block Bc that is stored in a memory 1306. The decoding device 13 also comprises a prediction module 1308. The prediction module 1308 determines the prediction block Bpred from the coding mode decoded for the current block by the entropy decoding module 1300 and possibly from motion data determined by the motion data reconstruction module. Advantageously, the decoding device according to the invention comprises a control module 1218 that implements step 22 of the reconstruction method. Step 24 of the reconstruction method is implemented in the different reconstruction modules 1300 and 1302 particularly.

1. A method of coding, in a video encoder, a current block of an image comprising:
determining, for said current block, current coding parameters comprising at least a prediction mode,
determining, for at least one neighbouring block of the current block, a neighbouring residual block from said current coding parameters (Pc),
determining for said current block a transform according to said neighbouring residual block;
coding said current block with said transform.

2. Method for coding according to claim 1, wherein said step of determination of a neighbouring residual block comprises the following steps for:
determining, for said neighbouring block, a prediction block using said current coding parameters, and
determining said neighbouring residual block by extracting from said reconstructed neighbouring block said prediction block.

3. Method for coding according to claim 1, wherein said current block being an INTRA type block predicted from neighbouring pixels, said step of determination of a neighbouring residual block comprises the steps for:
determining, for said neighbouring block, a prediction block from said neighbouring pixels using said current coding parameters, and
determining said neighbouring residual block by extracting from said reconstructed neighbouring block, said prediction block.

4-7. (canceled)

8. A method of decoding, in a video decoder, a bitstream for reconstructing a current block of an image comprising:
decoding from said bitstream, for said current block, current coding parameters comprising at least a prediction mode,
determining, for at least one neighbouring block of the current block, a neighbouring residual block from said current coding parameters,
determining for said current block a transform according to said neighbouring residual block, and
reconstructing said current block with said transform.

9-10. (canceled)

11. A method for coding according to claim 1, wherein said method further comprises determining a scanning order of coefficients of said current block according to said neighbouring residual block and wherein said current block is coded with said transform and according to said scanning order.

12. A method for coding according to claim 11, wherein said method further comprises determining a quantization type according to said neighbouring residual block and wherein said current block is coded with said transform, said quantization type and according to said scanning order.

13. A method according to claim 1, wherein determining for said current block a transform comprises
transforming said neighbouring residual block with each transform of a set of transforms:
coding each of said transformed neighbouring residual block into bits; and
determining the transform of the set for which the transformed neighbouring residual block is coded with the smallest number of bits.

14. A method according to claim 1, wherein current coding parameters further comprises motion data.

15. A method for decoding according to claim 8, wherein said method further comprises determining a scanning order of coefficients of said current block according to said neighbouring residual block and wherein said current block is reconstructed with said transform and according to said scanning order.

16. A method for decoding according to claim 8, wherein said method further comprises determining a quantization type according to said neighbouring residual block and wherein said current block is reconstructed with said transform, said quantization type and according to said scanning order.

17. A method for decoding according to claim 8, wherein said step of determination of a neighbouring residual block comprises the following steps for:
determining, for said neighbouring block, a prediction block using said current coding parameters, and
determining said neighbouring residual block by extracting from said reconstructed neighbouring block said prediction block.

18. A coding device for coding a current block of an image comprising:
a module configured to determine, for said current block, current coding parameters comprising at least a prediction mode,
a module configured to determine, for at least one neighbouring block of the current block, a neighbouring residual block from said current coding parameters,
a module configured to determine for said current block a transform according to said neighbouring residual block; and
a module configured to code said current block with said transform.

19. A coding device according to claim 18 wherein the device is adapted to execute the steps of the coding method according to claim 1.

20. A decoding device of a bitstream for reconstructing a current block of an image comprising:
a module configured to decode from said bistream, for said current block, current coding parameters comprising at least a prediction mode,
a module configured to determine, for at least one neighbouring block of the current block, a neighbouring residual block from said current coding parameters,
a module configured to determine for said current block a transform according to said neighbouring residual block; and
a module configured to reconstruct said current block with said transform.

21. A decoding device according to claim 20 wherein the device is adapted to execute the steps of the decoding method.
